(19) United States
(12) Patent Application Publication
(10) Pub. No.: US 2024/0166039 A1
(43) Pub. Date: May 23, 2024

(54) DEVICE, SYSTEM AND METHOD FOR MOUNTING A STORAGE MEANS FOR DRIVE ENERGY

(71) Applicant: MAN Truck & Bus SE, München (DE)

(72) Inventor: Alfred PETRASCH, München (DE)

(21) Appl. No.: 18/283,683

(22) PCT Filed: Jan. 25, 2022
(86) PCT No.: PCT/EP2022/054851

§ 371 Date: Sep. 22, 2023

(30) Foreign Application Priority Data
Mar. 23, 2021 (DE) 10 2021 107 134.8

(51) Int. Cl. B60K 1/04; F16B 5/02; H01M 50/249; H01M 50/262; B60L 50/60

(52) U.S. Cl. CPC B60K 1/04; F16B 5/0208; H01M 50/249; H01M 50/262; B60L 50/60; B60L 2200/36; H01M 2220/20

(57) ABSTRACT

The invention relates to a device, system, and method for mounting a storage unit for drive energy on a carrier frame of a vehicle. The invention further relates a vehicle having such a device.

The device (100) for holding a storage unit (3) for drive energy, e.g. of a high-voltage traction battery of a storage unit (3), comprises a first holder (100a; 100b) for fastening the device to the carrier frame (2) and a second holder (200a; 200b) for fastening the device to the storage unit (3), the second holder (200a; 200b) being configured such that it may be pushed onto, inserted into and/or latched onto the first holder (100a; 100b) in order to pre-position the first and second holders (100a; 100b; 200a; 200b) with respect to one another. This enables rapid assembly of the storage unit (3) on a production line, since the first and second holders can each be preassembled separately from one another on the carrier frame and storage unit, respectively, and may be brought together quickly and securely during assembly on the production line to hold the storage unit by pushing on, inserting into, and/or latching in the second holder (200a; 200b) on the first holder (100a; 100b).

The invention relates to a device, system, and method for mounting a storage unit for drive energy on a carrier frame of a vehicle, and to a vehicle having such a device.

In practice, the large and heavy high-voltage traction batteries for electrically powered commercial vehicles are known to be attached to the side of the carrier frame (support frame) of the commercial vehicle. For this purpose, the high-voltage traction batteries are pined to the carrier frame via a battery holder. However, a disadvantage of the approaches known from practical experience is that battery installation on the production line is time-consuming due to the high weight of the high-voltage traction battery and the complex pining process.

It is thus an object of the invention to provide an improved technique for mounting a storage unit for drive energy, with which disadvantages of conventional techniques for mounting may be avoided. In particular, the object of the invention is to enable rapid mounting of the storage unit on a production line and preferably to improve the handling of the storage unit during mounting and dismounting.

These objectives are solved by devices and methods with the features of the independent claims. Advantageous further embodiments are described in the dependent claims and the description.

In accordance with a first general aspect of the invention, there is provided a device for mounting a storage unit for drive energy on a carrier frame of a vehicle. The carrier frame may comprise two longitudinal frame members spaced apart from each other and interconnected by a plurality of cross members. The vehicle may be a commercial vehicle, such as a truck. In a preferred embodiment, the storage unit for drive energy is a storage unit for electrical energy, such as a high voltage traction battery for providing electrical drive energy to a vehicle. The device for holding a storage unit is also referred to hereinafter in brief as a holding device. The storage unit for drive energy is hereinafter referred to briefly as the storage unit.

According to the invention, the holding device comprises a first holder for fastening the device to the carrier frame and a second holder for fastening the device to the storage unit, wherein the second holder is configured to be pushed on (slid on), inserted into and/or latched onto the first holder, preferably for positioning or pre-positioning the first and second holders relative to one another.

This offers the advantage of enabling pre-assembly of the first holder to the carrier frame and of the second holder to the storage unit, so that when the storage unit is mounted on the carrier frame on an assembly production line (of the vehicle), a quick fastening is enabled in that the second holder pre-assembled on the storage unit can merely be pushed, inserted and/or latched into the first holder pre-assembled on the carrier frame.

The holding device can thus be configured as a two-part holding device comprising the first holder and the second holder, wherein the first holder is configured to be able to be fastened to the carrier frame independently of the second holder or without the second holder (in advance), and wherein the second holder is configured to be able to be fastened to the storage unit independently of the first holder or (in advance) without the first holder. The first holder may also be referred to as the first holder half and the second holder may be referred to as the second holder half. When the storage unit is mounted on the carrier frame during the assembly line production, the two halves of the holder may be brought together, preferably vertically (in the vehicle height direction), which is made possible in a simple manner by the fact that the second holder pre-mounted on the storage unit can merely be pushed, inserted and/or latched into the first holder pre-mounted on the carrier frame, preferably pushed, inserted and/or latched vertically (in the vehicle height direction). For this purpose, the two holders can each have appropriately configured, e.g. shape-corresponding, retaining elements which may be brought together in the manner of a sliding guide, plug-in connection and/or latch (snap-in) connection.

It has already been stated above that, preferably for the purpose of pre-positioning the first and second holders relative to one another, the second holder is configured so that it may be pushed onto, inserted into and/or latched onto the first holder. Pre-positioning with respect to each other means that the two holders are thereby positioned in a predetermined position with respect to each other. The two holders can then optionally be additionally clamped (braced), wedged or otherwise secured in this position, which will be explained in more detail below. Instead of pre-positioning, one could also speak of positioning the first and second holders relative to each other.

In one embodiment, the first holder and the second holder may be configured to slide into one another for positioning or pre-positioning in the manner of a sliding guide and may be brought together in a form-fitting manner. This offers the advantage that a form-fit guidance of the second holder is predetermined by the first holder during an assembly process, so that an assembly is simplified and the safety is increased. The form fit (interlocking fit) can additionally contribute to self-centering of the first and second holders.

For example, the sliding guide may be configured as a tongue-and-groove sliding guide with surfaces that engage behind each other at least in sections, preferably as a hammerhead or dovetail guide. This offers the advantage that the engaging surfaces additionally prevent unintentional movement of the holders relative to one another, in particular transversely to the sliding guide, and thus further increase safety during assembly. Alternatively, the rear-engaging surfaces can also be L-shaped. Any other shape that enables rear engagement and thus provides the intended function and is suitable as a sliding guide is conceivable in this context.

In a further embodiment, the first holder and the second holder can have an insertion (slide-in) groove on the one hand and at least one sliding element on the other hand at the mutual contact surfaces. This offers the advantage that the at least one sliding element and the one insertion groove define a clearly defined position between the first and second holder. Thus, in this embodiment, one of the two holders forms the insertion groove and the other forms the at least one sliding element. For example, the first holder may form and/or have the insertion groove, while the second holder forms and/or has the at least one sliding element.

In a further embodiment, the at least one sliding element may comprise a sliding element that has a movement-preventing shape directed perpendicular to the sliding direction, preferably in the transverse direction of the vehicle. This sliding element can have, for example, a T-shaped, hammerhead-shaped or dovetail-shaped cross section. This offers the advantage that once the first and second holders have been pre-positioned, movement perpendicular to the sliding direction is no longer possible, so that once the second holder has been pre-positioned, it is no longer possible for it to fall out of the first holder, making it unnecessary to support or secure the second holder.

Alternatively, the shape of the sliding element that prevents movement in the transverse direction of the vehicle may be configured on one side only, e.g. via an L-shaped sliding element. This offers the advantage that the design of the sliding element and the matching mating side may be simplified, thus saving costs. Alternatively, it is conceivable that the sliding element has a hook-shaped cross-section, configured on both sides or on one side.

Alternatively or additionally, the at least one sliding member may comprise a sliding member having a planar contact surface which, in the state of the sliding member inserted in the insertion groove, lies flat against a corresponding contact surface of the insertion groove, the planar contact surface extending in a plane which is parallel to the sliding direction and oblique to a width and depth direction of the first and second holders. Further, the first holder and the second holder may form an elongated member, wherein the sliding direction is longitudinal and/or parallel to a longitudinal axis of the first and second holders. In an assembled state of the device on a longitudinal frame member, the width direction may extend in the longitudinal direction of the vehicle and the depth direction may extend in the transverse direction of the vehicle, such that both the width direction and the depth direction are perpendicular to the longitudinal axis and thus the sliding direction. Furthermore, the planar contact surface can form an inclined surface which rests positively against the corresponding surfaces of the insertion groove of the first holder and thus prevents movement in the longitudinal direction of the vehicle.

In a further embodiment, the at least one sliding element may comprise a sliding element with a stop surface that may be locked by a locking element with a corresponding stop surface arranged in the insertion groove for pre-positioning the first and second holders relative to each other, which corresponds to pre-positioning in the sliding direction. In the pre-positioned state, the stop surfaces can lie flat against each other and each extend in a plane that is oblique to the sliding direction.

This offers the advantage that a fixed position is specified in the sliding direction, so that a fixed (end insertion) position is defined between the first and second holders when the holders are inserted. It is also advantageous that the stop surfaces lie flat against each other in the pre-positioned state and each extend in a plane that is oblique to the sliding direction, so that in a pre-positioned state, wedging of the second and first holders are already caused by the insertion that takes place.

In a further embodiment, the device may further comprise a clamping device for fixing, for clamping (bracing) and/or for compensating for setting losses of the first and second holders in the pre-positioned state relative to one another. This offers the advantage that the holders that have been pushed into one another cannot slip apart again against the push-in direction after fixing or bracing. Furthermore, the clamping device offers the advantage that setting losses caused by vibrations, for example, which cause the holders to slide or be displaced further into one another in the insertion direction, may be compensated for by appropriate means.

In a further embodiment, the clamping device may be configured to clamp the second holder in an insertion groove, preferably a T-slot or dovetail groove, of the first holder. This offers the advantage of enabling stable fixing of the second holder in the first holder.

In one embodiment, the clamping device may comprise a pre-clamping device, preferably in the form of a disc spring or a disc spring assembly, for maintaining the tensioning and/or wedging of the first and second holders, for example when settling occurs during vehicle operation. This offers the advantage that a defined force is stored in the clamping device by the pre-clamping device in the form of potential energy of a e.g. compressed disk spring, so that the setting losses already mentioned may be compensated more reliably by a subsequent pressing by the clamping device. As an alternative to the disk spring, it is also possible to use at least one helical compression spring or other suitable means that produce a comparable effect.

In a further embodiment, the clamping device may comprise a pressure piece and a screw acting on the pressure piece, with the pressure piece preferably pressing against at least one slanted edge of the first and/or second holder in the clamped state in order to wedge and/or clamp the first and second holders against one another. This offers the advantage that a defined force may be introduced by the screw, so that the pressure piece presses against the slanted edge of the first and/or second holder with an adjustable force. Furthermore, a cost-effective and structurally compact realization of a clamping device is made possible. A further advantage of the screw acting on the pressure piece is that preferably all tolerances occurring in the vertical direction between the first and second holders and the pressure piece may be compensated.

Furthermore, the clamping device comprising the pressure piece and the disk spring pack may have the function that when the second holder is clamped in a pre-positioned state in an upper region of the first holder, the pressure piece is clamped against the rear-engaging surfaces of the sliding guide, preferably against the L-profiles of the dovetail groove and/or T-groove and/or the tongue-and-groove-like sliding guide, of the first holder. Furthermore, the rear-engaging surfaces of the sliding guide and/or the L-profiles of the T-slot may be dimensioned and configured such that they can absorb the complete loads of the bracing.

In a possible further embodiment, the screw acting on the pressure piece may be held in a screw holder comprising an internal thread or a sleeve having an internal thread. The screw holder may be detachably fastened and/or secured to the first or second holder, wherein the pressure piece exerts or can exert a pressure force on the first or second holder in the state acted upon by the screw on a pressure surface of the first or second holder that is inclined with respect to the sliding direction, so that a force may be or is introduced in the sliding direction and transversely to the sliding direction for wedging and/or bracing the first and second holders. This offers the advantage that by applying a force through the screw to the pressure piece, a defined tensioning and/or fixing of the first and the second holder is made possible. This embodiment of the clamping device may be arranged at an upper end of the holding device.

Furthermore, a ball compensation disc may be installed between the screw applying pressure to the pressure piece and the disk spring assembly as well as the pressure piece, which compensates for misalignments and/or angular deviations between the screw acting on the pressure piece and the pressure piece. This offers the advantage that the screw acting on the pressure piece can exert pressure on the disk spring assembly and/or pressure piece in a defined manner in any installation position with a total pressure surface on the face side facing the disk spring assembly and/or pressure piece.

In an alternative embodiment of the aforementioned embodiment, the pressure piece can have a recess with a V-shaped cross section and two opposing inclined pressure surfaces, and the screw acting on the pressure piece may be an expansion screw which extends in the sliding direction, with the pressure piece exerting pressure in the sliding direction through the V-shaped recess via the two inclined pressure surfaces on corresponding pressure surfaces of the first and second holders for wedging and/or bracing the first and second holders.

This offers the advantage that the expansion screw can compensate for setting losses, whereby no additional component in the form of a disk spring, for example, is required to compensate for setting losses because the expansion screw itself acts as a tension spring.

It has already been stated above that the carrier frame may comprise two longitudinal frame members, preferably C-section members, spaced apart from one another and connected to one another via a plurality of cross members. Such carrier frames are typically used as chassis frames in commercial vehicles, such as trucks. In this case, the first holder may be configured for fastening to the frame longitudinal member, the second holder being configured such that it may be pushed on, inserted into and/or latched in from above on the first holder fastened to the frame longitudinal member in the vertical direction, corresponding to the vehicle height direction, in order to pre-position the first and second holders with respect to one another.

This offers the advantage that after the first holder has been pushed on, inserted and/or engaged in the second holder in the vertical direction, the first holder is already in the pre-positioned state and can no longer tip out in the transverse direction of the vehicle. Due to the vertical downward movement of the second holder into the first holder, the gravitational force already enables secure positioning of the holders in the pre-positioned state.

In a further embodiment, the first holder may comprise a locking element releasably attached to a lower end region, which forms a stop and/or a stop surface for the second holder during pre-positioning, wherein the locking element in the released, preferably removed, state allows the second holder, which has been pushed on, inserted and/or latched in the first holder, to be removed downwards in the vertical direction.

This offers the advantage that, if necessary, removal of the second holder with the storage unit attached, e.g. for replacement of a storage unit or for maintenance of a storage unit, is made possible quickly and easily without having to detach the first holder from the frame longitudinal member. This is particularly advantageous because the screw connection of the first holder to the frame longitudinal member is generally difficult to access when the vehicle battery is already mounted.

In one example of this embodiment, the detachably attached locking element may comprise a removable pin that forms or carries the locking element arranged in the insertion groove, as described above as an embodiment of a sliding element. The pin thus has a dual function: on the one hand, it serves as or forms or carries a locking element or stop to enable a defined end position or pre-positioning when the first and second holders are brought together. On the other hand, the pin enables quick downward removal of the held storage unit in the event of servicing.

For example, the removable pin can form the locking element (itself) arranged in the insertion groove, the corresponding stop surface of which is formed by a surface extending in the longitudinal direction of the pin. To form this stop surface, the pin can have a flat or flattened surface extending in the longitudinal direction of the pin, so that the pin does not have a round cross section. This offers the advantage of a structurally simple embodiment in that the pin directly forms a corresponding stop surface.

Furthermore, the removable pin may preferably be held transversely to the sliding direction in two holes in two outer legs of the first holder, and the two holes holding the removable pin may have a circular profile. Further, the sliding member of the second holder may be positioned centrally between the legs during pre-positioning. Further, the removable pin may protrude at outer dimensions of the legs or laterally outwardly from the legs of the first holder and may include an anti-loss feature and/or fixation of the removable pin. The loss prevention device may be formed by a through hole or a groove with a retaining plate held therein in the projecting area of the pin.

In the embodiment in which the loss prevention device has the groove and the retaining plate, the groove may be made in the removable pin in such a way that when the retaining plate engages in the groove, the stop surface of the pin is aligned at a 45° angle with respect to the insertion direction. In other words, the retaining plate can serve as axial securing of the pin and ensure that the stop surface of the removable pin, on which the second holder rests in the pre-positioned state, is already preset at an inclination of approximately 45°, thereby ensuring the correct position of the pin. Furthermore, the retaining plate may be detachably fastened to the leg, for example screwed in place.

Instead of forming the locking element arranged in the insertion groove itself, in an alternative embodiment the removable pin can carry the locking element arranged in the insertion groove, which is rotatably supported as a removable support piece by the removable pin. This offers the advantage that the removable support piece can provide a larger support surface than in the embodiment in which the pin directly provides the support surface.

Further, the removable pin may have a flattened area at its end portions in the longitudinal direction of the pin, and the removable pin may be supported via two vertical elongated holes in two legs of the first holder. Furthermore, the removable support piece may be positioned between the two legs and both legs of the first holder may have vertical threaded holes at the bottom side which protrude into the vertical elongated holes of the two legs holding the removable pin. Furthermore, loss prevention and/or fixation of the removable pin may be provided by two screws screwed into the vertical threaded holes and contacting the removable pin at the flattened areas, respectively, and fixing it vertically to the upper end of the elongated holes.

This offers the further advantage that after disassembly of the second holder and storage unit by removing the removable pin comprising the removable support piece and bringing the second holder out vertically downwards, reassembly, i.e. reassembly of the storage unit via the second holder, can take place. This is then done again by a vertical movement from below into the first holder and by reinserting the removable pin comprising the removable support piece. Here, clamping (bracing) and/or fixing is made possible by screwing the pins into the vertical threaded holes by moving the removable pin with the removable support piece in the vertical direction from below to the end of the vertical slotted holes and fixing it.

In a further embodiment, the first holder for fastening the first holder and the device to the carrier frame and the second holder for fastening the second holder and the device to the storage unit may each have through-openings arranged in a grid on their outer side regions, in which fastening means extending through the corresponding through-openings may be accommodated for force-fitting and/or form-fitting fixation of the first holder to the carrier frame and of the second holder to the storage unit. This offers the advantage that the first holder and the second holder may be securely fastened independently of one another to the carrier frame and to the storage unit, respectively, before the second holder is pushed into the first holder.

The first and/or second holder may each have two outer legs, each of which forms the outer side areas with through-openings arranged in a grid pattern. Further, the legs may be stiffened and/or strengthened via vertical rib-shaped reinforcements. Further, the vertical rib-shaped reinforcements may extend at outer regions of the legs. Further, the legs may be partially of non-solid, block-like construction. Preferably, the first and second holders are made of a solid metallic material that can provide the high retaining forces to hold the heavy storage unit.

In a further embodiment, the first holder may have the through-holes in a first portion of the first holder for securing the first holder to the carrier frame, preferably via screw connections. Further, the first holder may comprise a second sub-portion which, when the first holder is attached to the carrier frame, projects downwardly from the carrier frame and is not in direct contact with the carrier frame and comprises two legs. Further, the second holder may include through-holes arranged along substantially the entire length of the second holder and adapted to secure the second holder to the storage unit, preferably via threaded connections.

Alternatively or additionally, the first holder and the second holder may also be attached to the carrier frame or the storage unit by a material bond, e.g. via a welded joint.

In another embodiment, the first holder may include rib-like reinforcements that increase the stability and rigidity of the first holder. In yet another embodiment, the first holder may include through-holes in interstices of the rib-like reinforcements. In yet another embodiment, the first holder and the second holder may have approximately equal and/or similar contours and/or be approximately opposite each other in the pre-positioned state. Further, the first and/or the second holders may comprise recesses, preferably in a central region of the holders. This saves material and weight and thus costs.

Preferably, two holding devices (two devices for holding a storage unit, hereinafter referred to as a system for holding), as described above, are used for fastening the storage unit to the carrier frame, each holding device having a first and a second holder, respectively, as described above. Here, it is particularly advantageous if one of the holding devices is configured as a fixed bearing and the other as a floating bearing. This offers the advantage that positional tolerances may be compensated for by a fixed/floating bearing combination, so that the storage unit may be held without stress in the longitudinal direction of the vehicle in the first and second devices.

Accordingly, in accordance with another aspect of the invention, there is further provided a system and/or arrangement for mounting a storage unit for drive energy to a carrier frame of a vehicle, comprising a first mounting device and a second mounting device as described herein, wherein the first mounting device is configured as a fixed bearing and the second mounting device is configured as a floating bearing.

Alternatively, a system or arrangement with more than two devices for holding a drive energy storage unit is possible, of which at most one device is configured as a fixed bearing and all others as floating bearings. In a system with more than two devices, it is advantageous to place the fixed bearing in the center of the devices to avoid summation of multiple bearing tolerances or strains.

In one embodiment, the floating bearing may be configured to allow relative movement transverse to the sliding direction between the first holder and the second holder in a fixed and/or tensioned state of the first and second holder. This offers the advantage of compensating for tolerances and/or stresses and/or strains, e.g. due to the influence of heat during vehicle operation.

In a further embodiment, the fixed bearing may be configured to not allow relative movement transverse to the sliding direction between the first holder and the second holder when the first holder and the second holder are in a fixed and/or clamped (braced) state.

In a further embodiment, the first holder and the second holder of the fixed bearing may have, on the one hand, a slide-in groove and, on the other hand, at least one sliding element on the mutual contact surfaces, the at least one sliding element of the second holder projecting into an additional groove of the first holder and having, on outer edges in the sliding direction, planar contact surfaces which bear against planar contact surfaces of the additional groove, which firmly position the second holder relative to the first holder transversely to the sliding direction. This offers the advantage of self-centering of the second holder to the first holder.

The invention further relates to a vehicle, preferably commercial vehicle, having a carrier frame comprising two frame longitudinal members, preferably C-section members, spaced apart from each other and interconnected by a plurality of cross members. The vehicle further comprises a storage unit for propulsion energy, preferably a storage unit for electrical energy, and a device and/or system for holding the storage unit as disclosed herein, wherein the first holder is attached to the frame longitudinal member and the second holder is attached to the storage unit, preferably pinned and/or screwed and/or riveted.

According to a second general aspect of the invention, there is provided a method for attaching a storage unit for drive energy, preferably a storage unit for electric power, to a carrier frame of a vehicle, comprising the steps of:
providing a device or system as disclosed herein;
fastening the first holder to the carrier frame;
fasting of the second holder to the storage unit; and
fastening of the storage unit to the carrier frame by sliding, inserting and/or latching the second holder onto the first holder.

In order to avoid repetitions, features disclosed in connection with the device are also to be considered as disclosed as claimable features in connection with the method. The above-mentioned aspects and features according to the invention, in particular with regard to the design of the holding device or the system, thus also apply to the method.

The preferred embodiments and features of the invention described above may be combined with each other as desired. Further details and advantages of the invention are described below with reference to the accompanying figures. The figures show:

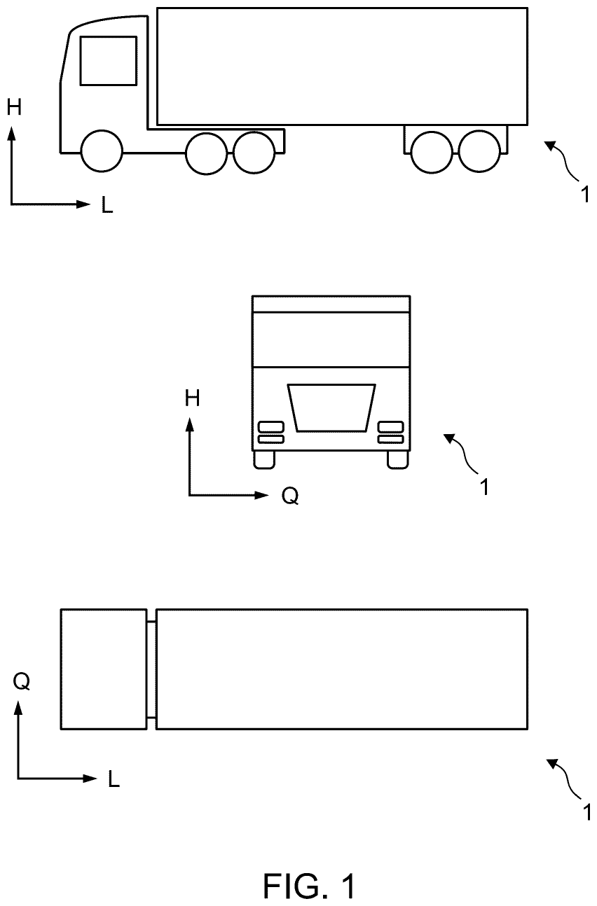

FIG. 1 a side, front and top view of a vehicle with respect to a vehicle height, vehicle transverse and vehicle longitudinal direction;

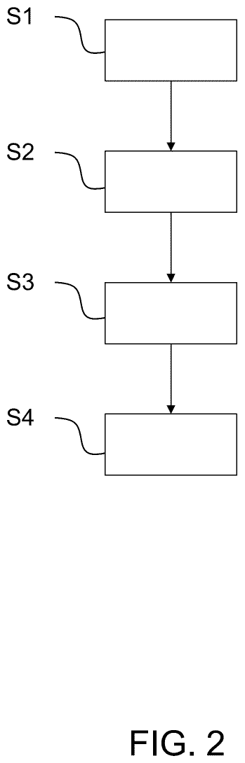

FIG. 2 a schematic flowchart illustrating a method of mounting a storage unit to a carrier frame of a vehicle according to one embodiment;

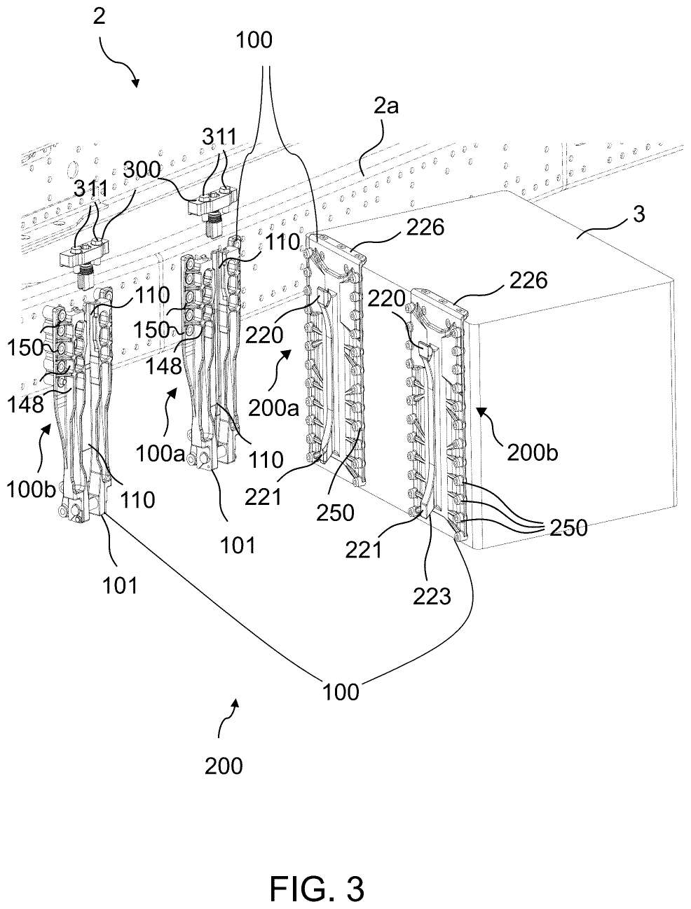

FIG. 3a system or two devices for mounting a storage unit for drive energy on a frame longitudinal member of a vehicle in the non-pre-positioned state according to one embodiment;

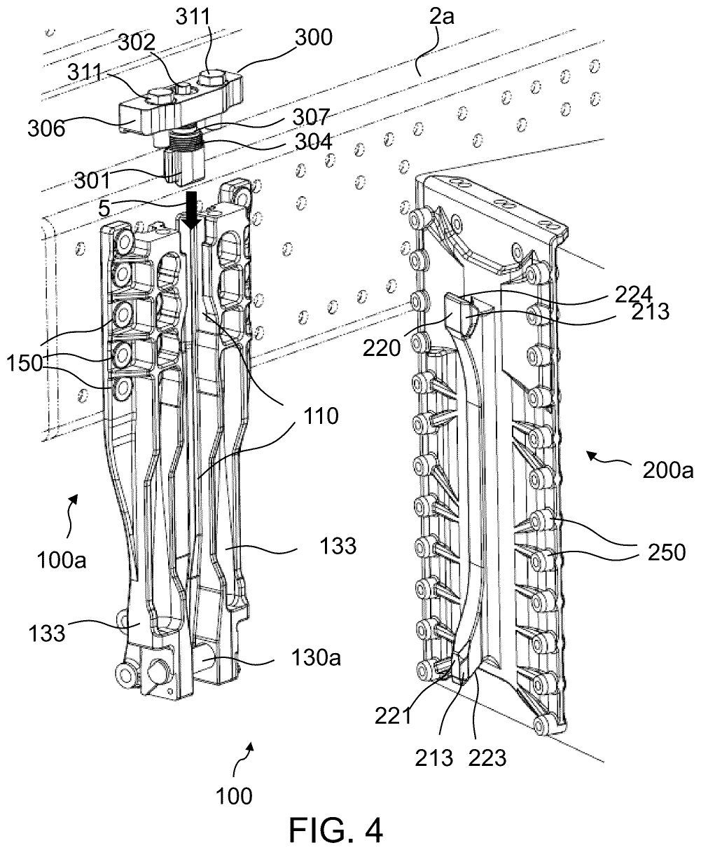

FIG. 4a device for mounting a storage unit for drive energy on a frame longitudinal member of a vehicle in the non-pre-positioned state according to one embodiment;

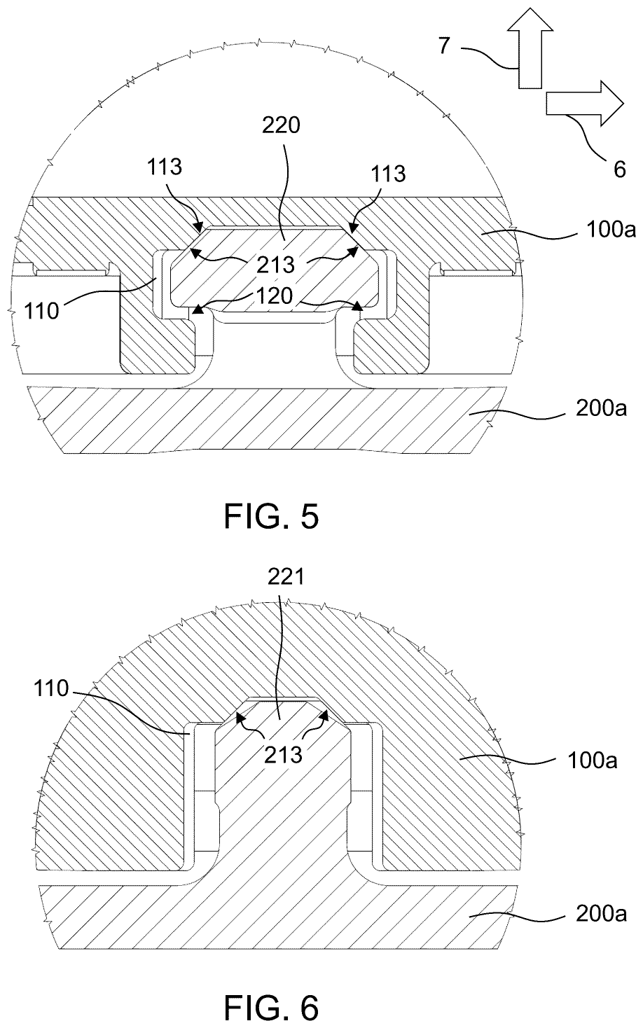

FIG. 5 a detailed view in plan and sectional view of a first and a second holder of a fixed bearing in the area of a dovetail-shaped sliding element in the pre-positioned state according to an embodiment;

FIG. 6 a top view in sectional view of a first and a second holder of a fixed bearing in a region of the first holder spaced from a frame longitudinal member in the pre-positioned state according to an embodiment;

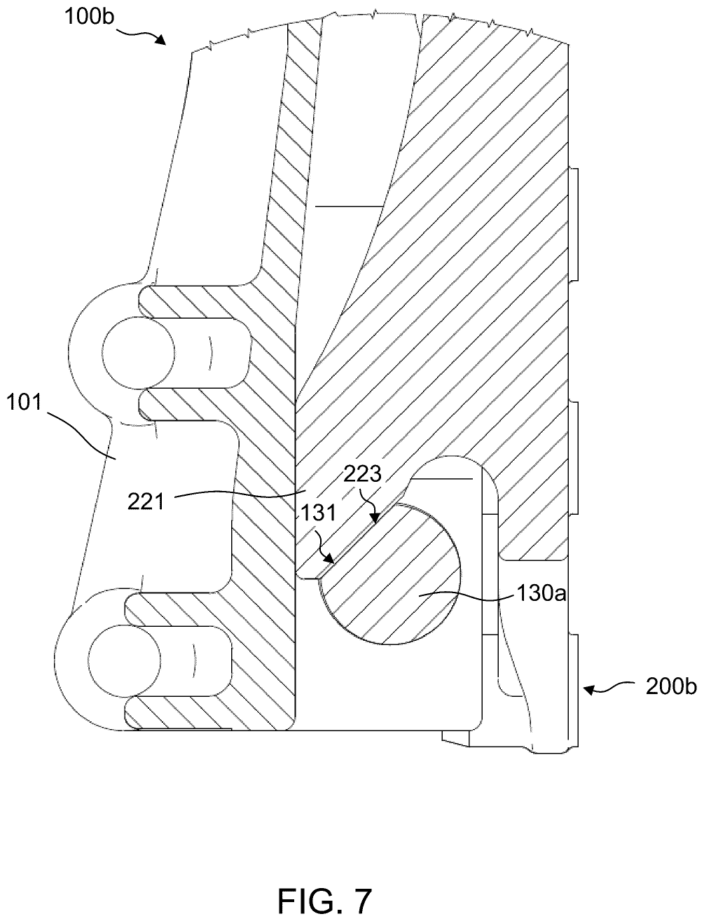

FIG. 7 a detailed side view and sectional view in a lower end region of the device in the pre-positioned state according to one embodiment;

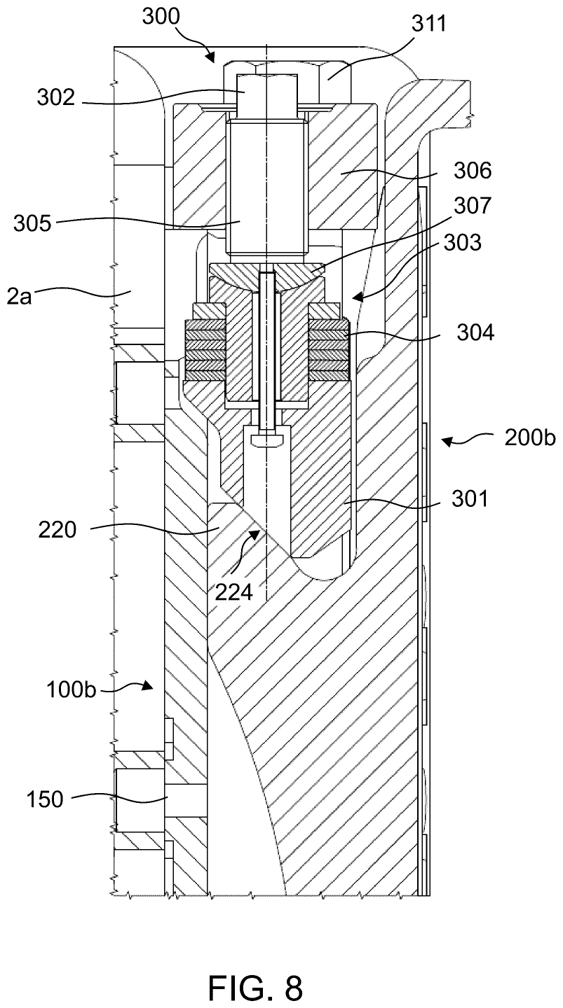

FIG. 8a side view in sectional view of a device in a clamped state according to one embodiment.

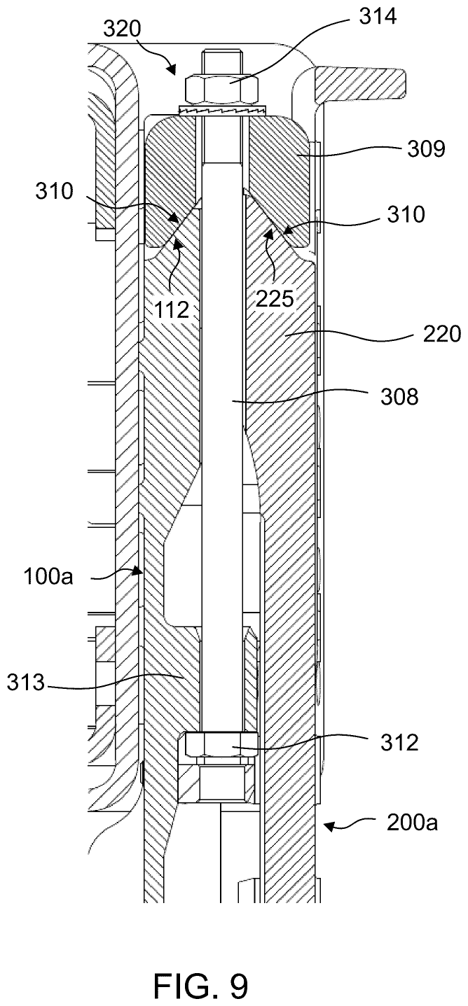

FIG. 9 a detailed side view and sectional view of a device in a tensioned state according to one embodiment;

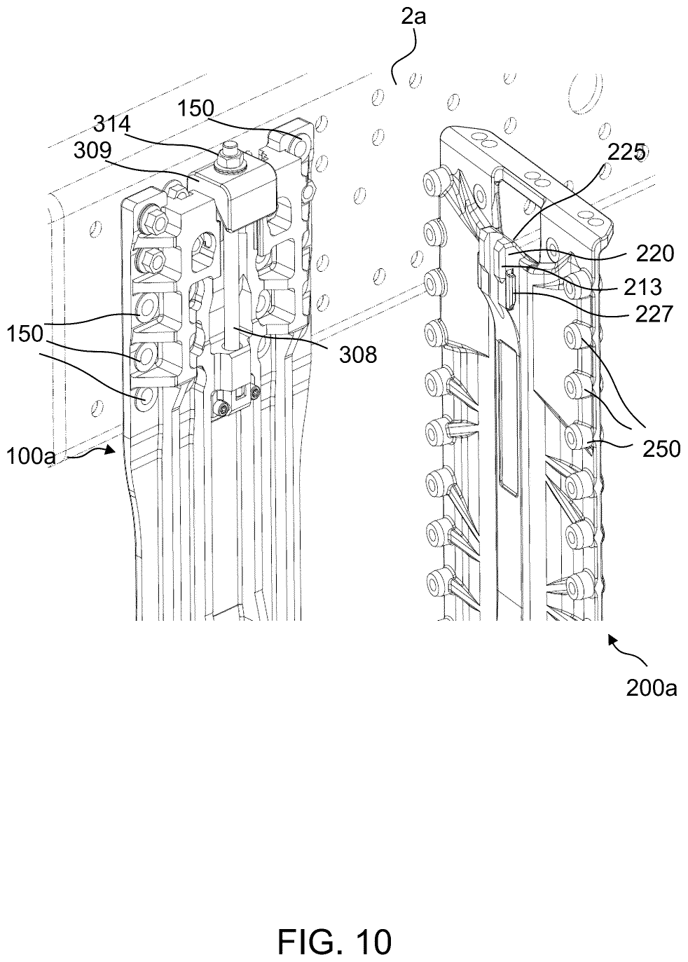

FIG. 10 a detailed view of a device on a frame longitudinal member of a vehicle in the non-pre-positioned state with a clamping device according to one embodiment;

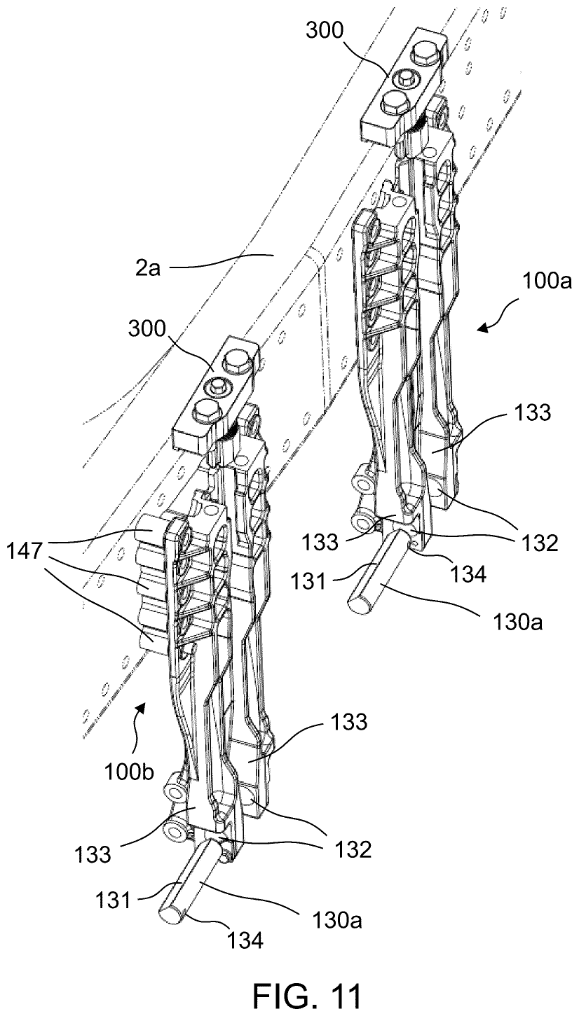

FIG. 11 a perspective view of two first holders attached to a frame longitudinal member with clamping devices and removable pins according to one embodiment;

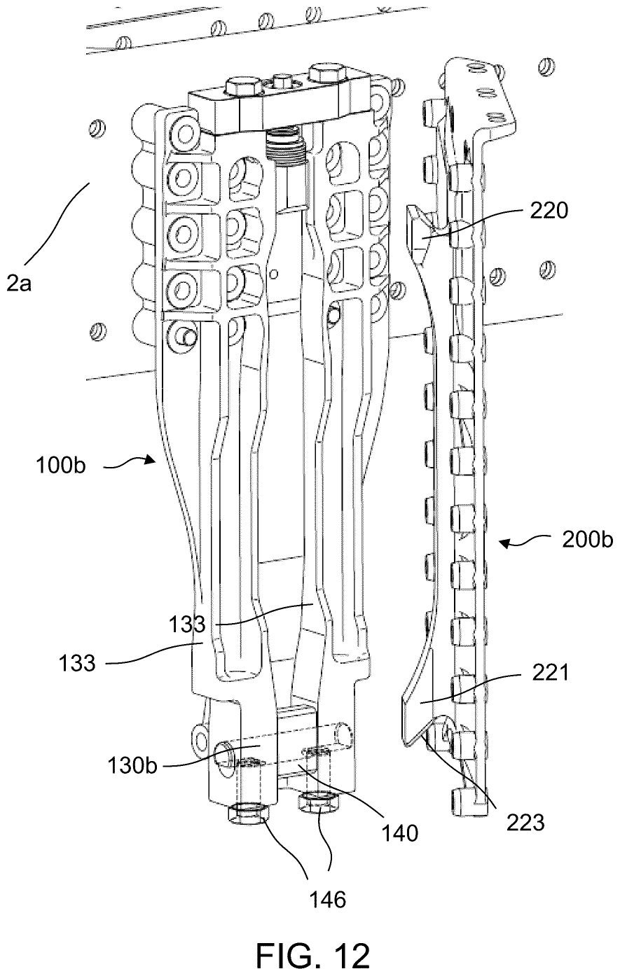

FIG. 12 a device with inserted locking element in the non-pre-positioned state according to one embodiment;

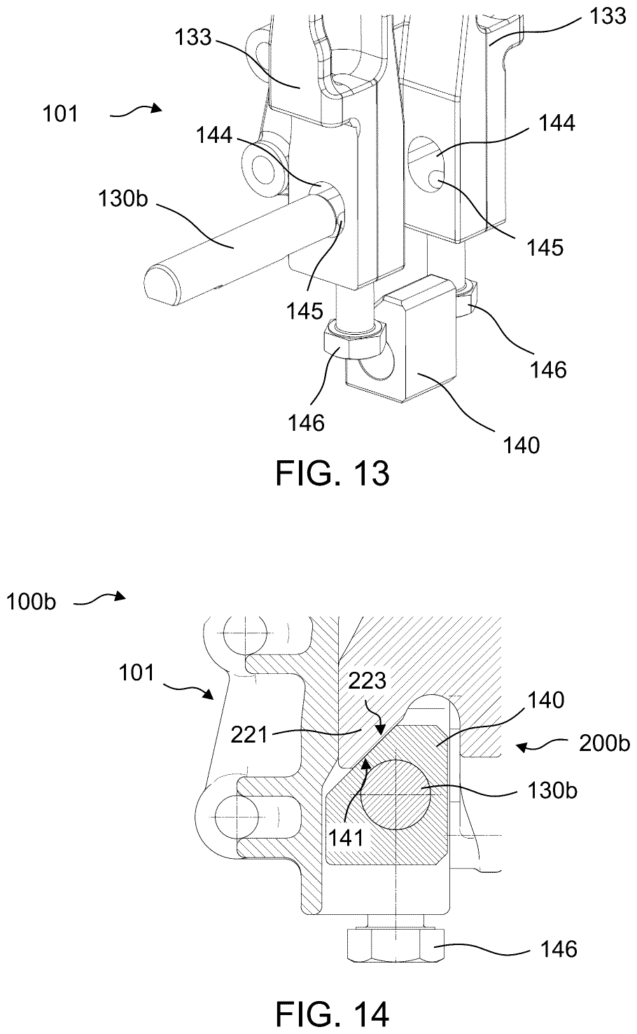

FIG. 13 an exploded view of a lower end portion of a first holder according to one embodiment;

FIG. 14 a side view in sectional view of a lower end portion of a device in the pre-positioned state according to one embodiment;

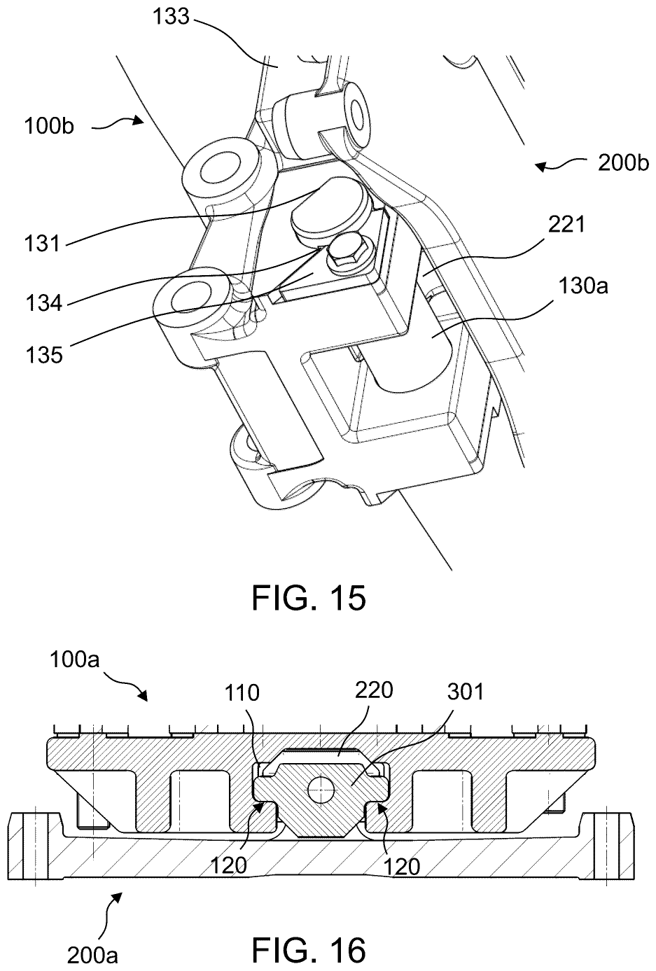

FIG. 15 a perspective view of a lower end portion of a first and a second holder in a pre-positioned state according to one embodiment; and

FIG. 16 a top view in sectional view of a first and a second holder of a fixed bearing in the tensioned state according to an embodiment.

FIG. 1 first shows a side, front and top view of a vehicle 1 with respect to a vehicle height H, vehicle transverse Q and vehicle longitudinal direction L. FIG. 1 serves to illustrate the vehicle height H, vehicle transverse Q and vehicle longitudinal direction L, which are referred to below in the description of the holding device.

The upper illustration of FIG. 1 shows the vehicle 1, in this case a commercial vehicle, in a side view, with a vehicle height direction H running vertically and a vehicle longitudinal direction L running horizontally. The middle embodiment shows the vehicle 1 in a front view, wherein a vehicle height direction H is vertical and a vehicle lateral direction Q is horizontal. The lower embodiment shows the vehicle 1 in a top view, wherein a vehicle transverse direction Q is vertical and a vehicle longitudinal direction L is horizontal.

FIG. 3 shows an example of two holding devices 100 for holding a storage unit 3 for electrical energy on a frame longitudinal member 2a of the commercial vehicle 1 in the non-pre-positioned state. The carrier frame 2 comprises two frame longitudinal members 2a spaced apart from each other and interconnected by a plurality of cross members. The storage unit 3 is a high-voltage traction battery for a commercial vehicle 1, which is attached to the carrier frame, in this case in particular to the frame longitudinal member 2a of the commercial vehicle 1.

Each of the holding devices 100 comprises a first holder 100a, 100b for fastening the device to the carrier frame 2 and the frame longitudinal member 2a, respectively, and a second holder for fastening the device to the storage unit 3. In FIG. 3, two first holders 100a, 100b, which are already shown in the (pre)mounted state on the frame longitudinal member 2a, and two second holders 200a, 200b, which are already shown in the (pre)mounted state on the storage unit 3, may be seen. The second holders 200a, 200b are attached to the housing of the storage unit 3.

The first holders 100a, 100b are configured to be attached to the frame longitudinal member 2a. The second holders 200a; 200b are configured to be fastened to the storage unit 3, in particular a storage unit housing. For this purpose, the first holders 100a, 100b and the second holders 200a, 200b each have through-openings 150, 250 arranged in a grid on their outer side regions, in which in each case fastening means extending through the corresponding through-openings may be accommodated for non-positive and/or positive fixing of the first holder 100a, 100b to the carrier frame 2 and of the second holder 200a, 200b to the storage unit 3.

The two first holders 100a, 100b are attached to the frame longitudinal member 2a of the vehicle 1, for example via through-openings 150 in an upper region in the vehicle height direction H, for example via screw connections. The through openings 150 extend in a grid-like manner at outer upper edge regions of the first holders 100a, 100b. Correspondingly, the two second holders 200a, 200b have through openings 250 arranged in a grid on outer side regions in the vertical direction (vehicle height direction H), via which the second holders 200a, 200b are fastened to the storage unit 3, e.g. via screws or pins.

The pre-assembly of the two halves of the holder can thus take place before the actual belt assembly of the storage unit 3 on the carrier frame 2. Pre-assembly means that the first holder may be fastened to the frame longitudinal member 2a and the second holder to the storage unit 3 at a time when there is good accessibility for the screw connection.

The holder halves are configured in such a way that they may be quickly and easily pushed vertically into one another, e.g. during assembly on a conveyor belt or assembly line. For this purpose, the holder halves form a sliding guide 110, 220. During assembly of the storage unit 3 on the frame side member 2a, the only step required is to slide the respective holder halves vertically into one another in order to bring them into a pre-positioned state and then to clamp them.

In this case, the first holder 100a and the second holder 200a are configured to slide vertically (in the vehicle height direction H) into one another for pre-positioning in the manner of a tongue-and-groove sliding guide and may be brought together in a form-fitting manner. The same applies analogously to the first holder 100b and second holder 200b, which also together form a tongue-and-groove or dovetail-type sliding guide. Here, the first holders form a slide-in groove 110 at contact surfaces with the second holder, while the second holders each have two sliding elements 220, 221 that engage in the slide-in groove of the associated first holder.

In this case, the respective upper sliding element 220 has a shape that prevents movement in the transverse direction of the vehicle, e.g. in that the upper sliding element 110 engaging in the sliding groove 110 has a T-shaped, hammerhead-shaped or dovetail-shaped cross section.

The lower sliding element 221 has a stop surface 223 in each case. For pre-positioning the first and second holders relative to each other, the lower sliding element may be locked by a locking element 130, 140 arranged in the insertion groove 110 and having a corresponding stop surface 131, 141. This locking during vertical merging of the first and second holders results in pre-positioning in the sliding direction of the two holder halves relative to one another, with the stop surfaces 131, 141, 223 resting flat against one another in the pre-positioned state and each extending in a plane that is oblique to the sliding direction.

In the pre-positioned state, the second holder halves 200a, 200b are already secured in the first holder halves 100a, 100b in such a way that they can no longer slide downwards out of the first holders 100a, 100b and can also no longer tip out in the transverse direction Q of the vehicle. How the respective holder halves 100a, 100b, 200a, 200b may be configured by way of example is explained below.

FIG. 3 further illustrates a support system 200 for supporting the storage unit 3, which is formed by a first support device 100 comprising a first holder 100a and a second holder 200a, and a second support device 100 comprising a first holder 100b and a second holder 200b.

The first device 100 is formed as a fixed bearing and the second device 100 is formed as a floating bearing, which will be explained in more detail below.

The two second holders 200a, 200b optionally include two short surfaces 226 at an upper end thereof that abut an upper surface of the storage unit 3. The short surfaces 226 increase the rigidity of the second holders 200a, 200b at an upper end region and minimize deflection of the second holders 200a, 200b when force is applied. The short surfaces 226 include recesses into which fasteners, such as screw heads, of the storage unit 3 extend.

The two second holders 200a, 200b each comprise two sliding elements 220, 221 projecting from a side of the second holders 200a, 200b opposite the storage 3. The sliding element 220 is wider than the sliding element 221 in the dimension of the longitudinal direction L of the vehicle when the device 100 is mounted.

In addition, the sliding elements 220, 221 of the second holder 200a differ from those of the second holder 200b in that the sliding element 220, 221 of the second holder 200a has contact surfaces 213 (see FIG. 4) at outer edges sloping in the sliding direction, which permit fixed positioning of the second holder 200a relative to the first holder 100a in the longitudinal direction L of the vehicle and thus form a fixed bearing.

To stabilize and stiffen the first holders 100a,100b, they include a ribbed reinforcement 148 located at least partially between the through openings 150.

Furthermore, the two first holders 100a, 100b each have the above-mentioned insertion groove 110 into which the sliding elements 220, 221 of the two second holders 200a, 200b may be inserted. Furthermore, the two first holders 100a, 100b have a lower end region 101 in the vehicle height direction H. The operation of the lower end region 101 will be discussed further in the description of the figures.

Furthermore, two clamping devices 300 are shown which provide for clamping (bracing), wedging and/or fixing of the holders 100a, 100b, 200a, 200b in a pre-positioned state. For this purpose, the clamping devices 300 are detachably connected to the first holders 100a, 100b via the fastening screws 311. The operation of the clamping devices 300 will be discussed in further detail in the description of the figures.

FIG. 4 shows a detailed view of a device 100 for holding a storage unit 3 for drive energy on a frame longitudinal member 2a of a vehicle 1 in the non-pre-positioned state.

At the sliding elements 220, 221 of the second holder 200a, the oblique contact surfaces 213 are shown, which prevent movement of the second holder 200a in the first holder 100a in the longitudinal direction L of the vehicle in a clamped state.

The clamping device 300 shown comprises a pressure piece 301, which is used to apply pressure to the inclined edge 224 on the sliding element 220. Furthermore, the clamping device 300 comprises a screw 302 which is rotatably held in the screw holder 306 and causes the pressure piece 301 to move downwards in the vehicle height direction H by rotation. Furthermore, the clamping device 300 comprises a disc spring assembly 304 which is located above the pressure piece 301 and in operative connection therewith and which is compressed when the clamping device 300 is pre-tensioned and, in the event of settling behavior, can vertically displace the pressure piece 301 held thereunder in the vehicle height direction H. Furthermore, the clamping device 300 preferably comprises a ball compensation disk 307, which compensates for misalignments and/or angular deviations between a vertical axis of the pin 302 and a vertical axis of the disk spring assembly 304 and/or pressure piece 301 and thus presses a thrust surface of the pin 302, which is on the end face and faces the disk spring assembly 304 and/or pressure piece 301, onto the disk spring assembly 304 and/or pressure piece 301 with the entire surface.

The sliding direction 5 is shown with an arrow below the pressure piece 301 and indicates the direction in which the second holder 200a is inserted into the first holder 100a in the shown embodiment.

The screw holder 306 is secured to an upper end of the first holder 100a, 100b by the mounting screws 311.

The first holder 100a includes two legs 133 at its lower end, between which the insertion groove 110 extends.

A first removable pin 130a, which is supported by the legs 133, forms a locking element in the sliding direction for the sliding element 221 of the second holder 200a, so that a stop surface 223 on an underside of the sliding element 221 rests on the first removable pin 130a.

FIG. 5 shows a detailed view in plan and sectional view of a first and a second holder 100a, 200a of a fixed bearing in the area of a dovetail-shaped sliding element 220 in the pre-positioned state according to one embodiment.

The sliding element 220 of the second holder 200a is located in the insertion groove 110 of the first holder 100a. The sliding element 220 comprises a planar contact surface 213 which, in the state of the sliding element 220 inserted in the insertion groove 110, lies flat against a corresponding contact surface 113 of the insertion groove 110 of the first holder 100a, the planar contact surface 213 extending in a plane which runs parallel to the sliding direction 5 and obliquely to a width and depth direction 6, 7 of the first and second holders 100a, 200a. The illustrated arrows in FIG. 5 show the width direction 6 and the depth direction 7 relative to the first and second holders 100a, 200a. The shape of the planar contact surfaces 213 prevents movement in the longitudinal direction L of the vehicle, correspondingly in the horizontal direction in FIG. 5.

The sectional rear-engaging surfaces 120 ensure that, in a pre-positioned state of the first holder 100a and the second holder 200a, falling out in the transverse direction Q of the vehicle is prevented. For this purpose, the insertion groove 110 comprises a sectionally encompassing shape that forms corresponding rear-engaging surfaces 120 for the sliding element 220. The dovetail guide shape is particularly suitable for this purpose. Further embodiments are possible which prevent the function of falling out, but still allow guiding in the insertion direction.

FIG. 6 shows a top view in sectional view of a first and a second holder 100a, 200a of a fixed bearing in a region of the first holder 100a spaced from a frame longitudinal member 2a in the pre-positioned state.

Analogous to FIG. 5, the sliding element 221 rests with its angled contact surfaces 213 against corresponding contact surfaces of the first holder 100a in the insertion groove 110. The difference in size of the sliding elements 220 and 221 from FIG. 5 and FIG. 6 may be clearly seen.

FIGS. 5 and 6 show the embodiment of a fixed bearing. In the floating bearing embodiment, the sliding elements 220 and 221 do not comprise inclined contact surfaces 213, and the insertion groove 110 of the first holder 100b also does not comprise corresponding contact surfaces. The second holder 200b thus lies flat against the first holder 100b, allowing small compensating movements relative between the first holder 100b and the second holder 200b.

FIG. 7 shows a detailed side view and sectional view in a lower end portion of the device 100 in the pre-positioned state according to one embodiment.

As previously stated, the sliding member 221 of the second holder 200b lies flat against the first holder 100b in the pre-positioned state, allowing relative movement in the transverse direction Q of the vehicle between the first holder 100b and the second holder 200b.

The first removable pin 130a with its stop surface 131 forms the locking element for the sliding element 221 of the second holder 200b in the insertion direction, so that the stop surface 223 of the sliding element 221 rests flat on the stop surface 131 of the first removable pin 130a in the pre-positioned state. The sliding element 221 is wedge-shaped in cross-section, so that already by pushing the second holder 200b into the first holder 100b by the gravitational force a centering and a joining of the first and the second holder 100b, 200b is effected without any additional bracing or fixing.

FIG. 8 shows a side view in sectional view of a device 100 in a clamped state according to one embodiment.

The clamping device 300 is screwed to the first holder 100b by the fastening screws 311 via the screw holder 306. In the embodiment shown, an internal thread 305 is formed in the screw holder 306. The screw 302 is retained in the internal thread 305, which when rotated produces a vertical downward movement of the preload device 303 and the underlying pressure piece 301.

As an alternative to the internal thread 305 inserted into the screw holder 306, a sleeve having an internal thread 305 may be inserted into the screw holder 306 as an interference fit to hold the screw 302 (not shown here).

The disk (Belleville) spring assembly 304 of the preload device 303 is already compressed, and the underlying pressure piece 301 exerts pressure on the slanted edge 224 of the sliding element 220 of the second holder 200b. The pressure of the clamping device 300 firmly clamps the second holder 200b to the first holder 100b. Due to the inclined shape of the inclined edge 224 in the direction of insertion, the pressure of the pressure piece 301 causes a force both in the direction of insertion and transversely thereto, namely in the direction of the first holder 100b. The first and the second holder 100a, 200b are thus clamped (braced) and fixed to each other both vertically and horizontally.

If, as a result of vibrations or other influences during vehicle operation, the second holder 200b should be displaced further down in the vertical direction (vehicle height direction H), i.e. there is a loss of setting, this displacement is compensated for by the pretensioning of the disk spring pack 4, so that there is still effective bracing and fixing of the first and second holders 100b,200b and no vertical movements are permitted as a result of shocks, vibrations or the like.

Furthermore, FIG. 8 shows how through openings 150 of the first holder 100b are arranged in alignment with corresponding openings of the frame longitudinal member 2a. The through openings 150 for fastening the first holder 100b can also be provided at suitable locations distributed over the entire holder or can also be provided in central regions of the first holder 100b in addition to the through openings 150 provided at the edge regions.

FIG. 9 shows a detailed side view and sectional view of a device 100 in a clamped (braced) state according to one embodiment.

The clamping device 320 represents an alternative embodiment to the clamping device 300 already shown, with which the first and second holders 100a, 200a are clamped together.

The clamping device 320 comprises a pressure piece 309 with a recess that is V-shaped in cross-section and comprises inclined thrust surfaces 310 on its respective sides. A screw 308 projects through the pressure piece 309, extends vertically downward, and has a screw head 312 that engages the first holder via a projection 313. Above the pressure piece 309, the screw 308 projects out of the pressure piece 309 and is retained by a nut 314.

The pressure surfaces 310 rest, on the one hand, on a pressure surface 112 of the first holder 100a and, on the other hand, on a pressure surface 225 of the sliding element 220 of the second holder 200a, which have a corresponding slope relative to the direction of insertion and are configured such that the pressure surfaces 310, 112, 225 rest on one another in a planar manner.

Turning the nut 314 applies tension to the screw 308 so that the pressure piece 309 braces the first and second holders 100a, 200a together, both in the direction of insertion and transversely to the direction of insertion relative to each other, due to the geometry of the thrust surfaces 310, 112, 225.

FIG. 10 shows a detailed view of a device 100 on a frame longitudinal member 2a of a vehicle 1 in the non-pre-positioned state with a clamping device 320 according to one embodiment.

The clamping device 320 shown corresponds to that shown in FIG. 9. The screw 308, the pressure piece 309 and the nut 314 are attached to the first holder 100a. In this embodiment, the sliding element 220 of the second holder 200a is divided in the middle by a vertical opening so that the screw 308 can pass through this vertical opening in the pre-positioned state (see also FIG. 9). At an upper portion of the sliding element 220, the sliding element 225 includes angled contact surfaces 213, in accordance with an embodiment of a fixed bearing. At a lower portion of the sliding element 220, lateral protrusions 227 protrude to form abutment surfaces so that it is no longer possible for the second holder 200a to fall out of the first holder 100a in the pre-positioned state.

FIG. 11 shows a perspective view of two first holders 100a, 100b attached to a frame longitudinal member 2a with clamping devices 300 and first removable pins 130a.

The first two holders 100a, 100b are attached to the frame longitudinal member 2a. However, the longitudinal frame member 2a does not run in a straight line, but has a bent course. In order to compensate for this bent course, in this example distance compensating elements 147 in the form of spacer sleeves are placed between the frame longitudinal member 2a and the first holder 100b, which keep a transverse distance from a longitudinal center plane of the vehicle 1 the same for both first devices 100a, 100b. The distance compensating elements 147 may be in the form of sleeves, but can also be in the form of flat components which can extend in a wedge shape between the frame longitudinal member and the first holder 100b. The illustration in FIG. 11 is purely exemplary and is only intended to clarify the function of a distance compensation element 147. It is also conceivable to have distance compensation elements 147 on more than one first holder 100b, depending on the course of a frame longitudinal member 2a. The first holders 100a, 100b run in a plane parallel to a vertical longitudinal center plane of the vehicle 1.

Further shown are first removable pins 130a having a stop surface 131 in the longitudinal direction of the pin, which serve as a stop surface 131 for a stop surface 223 of a sliding member 223. The first removable pins 130a are held in holes 132 in the legs 133. The holes 132 have a circular profile, such that the first removable pins 130a are in flat contact in the holes 132 due to their own partially cylindrical shape. The first removable pins 130a each comprise a groove 134 in end regions, in which a retaining plate 135 engages, which is detachably fastened to an outer side region of the legs 133 in such a way that the retaining plate 135 axially secures the removable pin 130a and sets an inclination of the stop surface 131 with respect to the insertion direction 5 preferably to 45°. In other words, the retaining plate 135 serves as axial securing of the removable pin 130a and ensures that the stop surface 131 of the removable pin 130a, on which the second holder 200a, 200b rests in the pre-positioned state, is already preset at an inclination of approximately 45°, thereby ensuring the correct position of the removable pin 130a.

FIG. 12 shows a device 100 with inserted locking element 140 in the non-pre-positioned state according to one embodiment.

The first holder 100b is attached to the frame longitudinal member 2a and includes an alternative embodiment for locking the second holder 200b in the first holder 100b in the sliding direction. At the lower end of the first holder 100b, a second removable pin 130b is shown carrying a locking element 140 that is seated between legs 133 of the first holder 100b and is rotatably supported on the second removable pin 130b. Thus, for the stop surface 223 of the sliding element 221 of the second holder 200b, the locking element 140 forms the counterpart. Structural details will be further discussed in FIGS. 13 and 14.

FIG. 13 shows an exploded view of a lower end portion 101 of a first holder 100a, 100b according to one embodiment.

The lower end portion 101 includes two legs 133 in which two vertical elongated holes 144 are formed at the same level. Furthermore, vertical threaded holes 145 are made in the two legs 133, which project into the vertical elongated holes 144 from below. The pins 146 are screwed into these threaded holes 145. The second removable pin 130b has two opposing flat areas at end regions in the longitudinal direction of the pin, which serve as contact surfaces for the pins 146. When the screws 146 are screwed in, they press the second removable pin 130b upward at its flat portions in the vertical direction so that the pin is fixed between the upper end of the vertical elongated holes 144 and the screws 146. As a result, the locking member 140, which is rotatably supported on the second removable pin 130b, is also moved upward in the vertical direction (i.e., opposite to the push-in direction). The upward sliding of the second holder 200a, 200b (not shown here) compresses the disk spring assembly 304 of the clamping device 300 (not shown here), so that after successful insertion of the second holder, setting losses may be compensated again during vehicle operation. The same mechanism is also possible with the clamping device 320.

FIG. 14 shows a side view in sectional view of a lower end portion 101 of a device 100 in the pre-positioned state according to one embodiment.

The operation described in FIG. 13 is illustrated in FIG. 14 in an assembled state. The locking element 140 includes a stop surface 141 that is in surface contact with the stop surface 223 of the sliding element 221 of the second holder 200b. The second removable pin 130b rotatably supports the locking element 140 through a circular through hole in the locking element 140. The pins 146 are not screwed all the way into the threaded holes 145 on the underside of the legs 133 to avoid double fits.

FIG. 15 shows a perspective view of a lower end portion 101 of a first and a second holder 100b, 200b in a pre-positioned state according to one embodiment.

Shown is how the first removable pin 130a forms a stop for the sliding element 221 of the second holder 200b. The first removable pin 130a has a groove 134 in which a retaining plate 135 engages. The retaining plate 135 is detachably secured to a laterally outer portion of the leg 133 by a fastener, and is mounted to engage the groove 134 in such a manner that the stop surface 131 of the removable pin 130a is positioned at a 45° angle with respect to an insertion direction. In the example shown, the retaining plate 135 has a substantially triangular shape. Further, in the illustrated embodiment, the retaining plate 135 does not protrude beyond the leg 133 at a lateral contour, but is flush with the leg 133. Furthermore, the retaining plate 135 is arranged in a rotationally fixed manner in the installed state, whereby in the embodiment shown, the retaining plate 135 is prevented from rotating by an edge of the leg 133.

FIG. 16 shows a top view in sectional view of a first and a second holder 100a, 200a of a fixed bearing in the clamped state according to one embodiment.

It is made clear in this embodiment that the pressure piece 301 in the clamped state, on the one hand, exerts pressure on the sliding element 220 and, at the same time, rests with left- and right-sided flanks in the insertion groove 110 in the transverse direction Q of the vehicle in order to enable stable guiding and good force transmission of the pressure piece between the two holders 100a, 200a when the holders 100a, 200a are clamped. In other words, it may be seen that the pressure piece 301 is clamped against the rear-engaging surfaces 120 of the sliding guide of the first holder 100a.

FIG. 2 shows a schematic flow chart illustrating a method of attaching a storage unit 3 to a carrier frame 2 of a vehicle 1 in accordance with one embodiment.

Step S1 comprises providing a device 100 or a system 200 according to the disclosure herein. The device comprises at least one first holder 100a, 100b and at least one second holder 200a, 200b, which are configured to slide into each other and/or to be inserted into each other and/or to be latched onto each other.

Step S2 comprises the fastening of the first holder 100a, 100b to the carrier frame 2. Here, the fastening may comprise screwing, pinning, gluing, welding, riveting or other form-fitting, force-fitting or material-fitting fastening forms. Necessary means for a fastening, such as through-holes 150, are provided on the first holders 100a, 100b.

Step S3 comprises fastening the second holder 200a, 200b to the storage unit 3, referring to the fastening forms of step S2. The second holders 200a, 200b also comprise means for a fastening, such as through-holes 250, for a fastening of the second holder 200a, 200b to the storage unit 3.

Step S4 comprises attaching the storage unit 3 to the carrier frame 2 by sliding, inserting and/or engaging the second holder 200a, 200b onto the first holder 100a, 100b. This step may be performed under a manual guidance but also in an automated way. It has already been mentioned above that steps S2 and S3 may be carried out as part of a pre-assembly process, so that during the actual tape assembly of the storage unit 3 on the frame longitudinal member 2a, only step S4 is carried out, whereby the two halves of the holder are brought together vertically one inside the other. Optionally, the process can include further steps such as fixing the two halves of the holder to one another (after they have been brought together vertically) by means of a clamping device which can compensate for setting losses occurring later during vehicle operation and thus avoid undesirable play.

Certain representations and embodiments in the figures, which have been referred to an embodiment comprising a fixed bearing or comprising a floating bearing, are not limited to the respective embodiment, but may be combined with each other, so that different embodiments of the clamping devices, fixed bearings and floating bearings and locking elements may be combined with each other.

Although the invention has been described with reference to specific embodiments, it is apparent to one skilled in the art that various modifications may be carried out and equivalents may be used as substitutes without departing from the scope of the invention. Consequently, the invention is not intended to be limited to the disclosed embodiments, but is intended to encompass all embodiments that fall within the scope of the appended claims. In particular, the invention also claims protection for the subject matter and features of the dependent claims independent of the referenced claims.

### LIST OF REFERENCE SIGNS

1 Vehicle, e.g. commercial vehicle
2 Carrier frame
2a Frame longitudinal member
3 Storage unit
5 Sliding direction
6 Width direction
7 Depth direction
100 Device for holding a storage unit
100a First holder
100b First holder
101 Lower end area of the first holder
110 Slide-in groove
112 Inclined edge, pressing surface
113 Corresponding contact area
120 Sectionally undercutting surfaces
130 Locking element
130a First removable pint
130b Second removable pin
131 Attachment surface
132 holes
133 Leg
134 Groove
135 Holding plate
140 Locking element
141 Attachment surface
144 Vertical oblong hole
145 Vertical threaded hole
146 Screw
147 Distance compensation elements
148 Ribbed reinforcement
150 Passage openings
200 System for holding a storage tank
200a Second holder
200b Second holder
213 Flat contact surface
220 Sliding element
221 Sliding element
223 Attachment surface
224 Slanted edge
225 Inclined edge, pressing surface
226 Short surfaces
227 Side protrusions
250 Passage openings
300 Tensioning device
301 Pressure piece
302 Screw
303 Preload device
304 Disc spring pack
305 Sleeve with one internal thread
306 Screw holder
307 Ball compensation washer
308 Screw
309 Pressure piece
310 Slanted printing area
311 Fixing screw
312 Screw head
313 Protrusion
314 Nut
320 Clamping device
H Height direction of vehicle
Q Cross direction of vehicle
L Longitudinal direction of vehicle

1-22. (canceled)

23. A device for mounting a storage unit for drive energy on a carrier frame of a vehicle, comprising:
a first holder for fastening the device to the carrier frame and a second holder for fastening the device to the storage unit, the second holder being configured such that it may be pushed on, inserted into and/or latched in on the first holder in order to pre-position the first and second holders with respect to one another.

24. The device according to claim 23, wherein the first holder and the second holder, for the pre-positioning, are configured to slide into each other in the manner of a sliding guide and may be brought together in a form-fitting manner.

25. The device according to claim 24, wherein the sliding guide is configured as a tongue-and-groove-like sliding guide with surfaces engaging behind one another at least in sections.

26. The device according to claim 23, wherein
the first holder and the second holder comprise, on the one hand, an insertion groove and, on the other hand, at least one sliding element at the mutual contact surfaces, or
the storage unit is for electrical energy, or
the sliding guide is configured as a hammerhead or dovetail guide.

27. The device according to claim 26, wherein the first holder comprises an insertion groove and the second holder comprises at least one sliding element for insertion into the insertion groove.

28. The device of claim 26, wherein the at least one sliding member comprises a sliding member,
a) which has a shape that prevents movements directed perpendicular to the slide direction; or
b) which has a planar contact surface which, in the state of the sliding element inserted in the insertion groove, bears flat against a corresponding contact surface of the insertion groove, the planar contact surface extending in a plane which runs parallel to the sliding direction and obliquely to a width and depth direction of the first and second holders.

29. The device according to claim 28, wherein
the at least one sliding element comprises a sliding element with a stop surface which, for pre-positioning of the first and second holders relative to one another, is lockable by a locking element arranged in the insertion groove and having a corresponding stop surface, for pre-positioning in the sliding direction, the stop surfaces bearing flat against one another in the pre-positioned state and each extending in a plane which is oblique to the sliding direction, or
the at least one sliding member comprises a sliding member which has a shape that prevents movements directed perpendicular to the slide direction in the transverse direction of the vehicle or
the at least one sliding member comprises a sliding member having a T-shaped, hammerhead-shaped or dovetail-shaped cross-section.

30. The device according to claim 23, further comprising a clamping device for fixing, clamping and/or compensating for setting losses of the first and second holders in the pre-positioned state relative to each other.

31. The device according to claim 30, wherein the clamping device is configured to clamp the second holder in an insertion groove of the first holder.

32. The device according to claim 30, wherein
the clamping device comprises a preload device for maintaining the clamping and/or wedging of the first and second holders, or
the clamping device is configured to clamp the second holder in an insertion groove of the first holder wherein the insertion groove is a T-groove or dovetail groove.

33. The device according to claim 32, wherein
the clamping device comprises a pressure piece and a screw acting on the pressure piece, or
the preload device is configured as a disc spring or as a disc spring assembly, or
the preload device is for maintaining the clamping and/or wedging of the first and second holders when settling behavior occurs during vehicle operation.

34. The device according to claim 33, wherein
a) the screw acting on the pressure piece is held in a screw holder comprising an internal thread or a sleeve with an internal thread, which screw holder is detachably fastened to the first holder, the pressure piece exerting pressure on the second holder in the state loaded by the screw, so that a force is applied in the sliding direction and transversely to the sliding direction for wedging and/or clamping the first and the second holder; or
b) the pressure piece has a recess of V-shaped cross-section with two opposing oblique pressure surfaces, and the screw acting on the pressure piece is an expansion screw which extends in the sliding direction, the pressure piece exerting pressure in the sliding direction through the V-shaped recess via the two oblique pressure surfaces on corresponding pressure surfaces of the first and second holders for wedging and/or clamping the first and second holders, or
c) the clamping device comprises a pressure piece and a screw acting on the pressure piece wherein the pressure piece, in the clamped state, is pressing against at least one inclined edge of the first and/or second holder in order to wedge and/or clamp the first and second holders against one another.

35. The device according to claim 23, wherein the carrier frame comprises two frame longitudinal members spaced apart from one another and connected to one another via a plurality of cross members, wherein the first holder is configured for fastening to the frame longitudinal member, wherein, for pre-positioning the first and second holders relative to one another, the second holder being configured such that it may be pushed onto, inserted into and/or latched onto the first holder, which is fastened to the frame longitudinal member, from above in the vertical direction, corresponding to the vehicle height direction.

36. The device according to claim 35, further comprising a locking element detachably fixed to a lower end portion of the first holder and forming a stop and/or a stop surface for the second holder during pre-positioning, wherein the locking element in the released state enables the second holder, which has been pushed on, inserted and/or latched in the first holder, to be removed downwards in the vertical direction.

37. The device of claim 36, wherein
the two frame longitudinal members are C-section members, or
the locking element in the released state is in a removed state

38. The device of claim 36, wherein
the releasably secured locking member comprises a removable pin forming or supporting the locking member disposed in the insertion groove.

39. The device of claim 38, wherein the removable pin forms the locking element disposed in the insertion groove, the corresponding stop surface of which is formed by a surface extending in the longitudinal direction of the pin.

40. The device of claim 38, wherein the removable pin carries the locking member disposed in the insertion groove, the locking member being rotatably supported as a removable support piece by the removable pin.

41. The device according to claim 23, wherein the first holder and the second holder each have through-openings arranged in the form of a grid on their outer side regions, in which through-openings fastening means extending through the corresponding through-openings may be accommodated for force-fitting and/or form-fitting fixation of the first holder to the carrier frame and of the second holder to the storage unit.

42. A system for mounting a storage unit for drive energy on a carrier frame of a vehicle, comprising a first device and a second device, each of which is configured according to claim 23, the first device being configured as a fixed bearing and the second device being configured as a floating bearing.

43. The system of claim 42, wherein
a) the floating bearing allows a relative movement transverse to the sliding direction between the first holder and the second holder in a fixed and/or clamped state of the first and the second holder; or
b) the fixed bearing does not permit any relative movement transversely to the sliding direction between the first holder and the second holder in a fixed and/or clamped state of the first and the second holder, or
c) the storage unit is for electrical energy.

44. A vehicle comprising
a) a carrier frame comprising two frame longitudinal members spaced apart from each other and interconnected by a plurality of cross members;
b) a storage unit for drive energy; and
c) a device according to claim 23 or a system according to claim 42;
wherein the first holder is fastened to the frame longitudinal member and the second holder is fastened to the storage unit.

45. The vehicle of claim 44 wherein
the vehicle is a commercial vehicle, or
the two frame longitudinal members are C-section members, or
the storage unit is for electrical energy, or
the first and second holders are fastened by being pinned or screwed or riveted.

46. A method for attaching a storage unit for drive energy to a carrier frame of a vehicle, comprising the steps:
providing a device according to claim 23 or a system according to claim 42;
fastening of the first holder to the carrier frame;
fastening of the second holder to the storage unit; and
fastening of the storage unit to the carrier frame by pushing the second holder onto the first holder, by inserting the second holder into the first holder and/or by latching the second holder in the first holder.

47. The method of claim 46 wherein the storage unit is for electrical energy.
